(19) United States
(12) Patent Application Publication
(10) Pub. No.: US 2015/0324666 A1
(43) Pub. Date: Nov. 12, 2015

(54) ROCKING OPERATING APPARATUS FOR A PUSH-PUSH CARD READER

(71) Applicant: AMPHENOL-TUCHEL ELECTRONICS GMBH, Heilbronn (DE)

(72) Inventor: Eckhard SCHEWE, Heilbronn (DE)

(21) Appl. No.: 14/758,979

(22) PCT Filed: Dec. 7, 2013
(86) PCT No.: PCT/EP2013/003696

§ 371 Date: Jul. 2, 2015

(30) Foreign Application Priority Data
Jan. 29, 2013 (DE) 10 2013 001 470.0

(51) Int. Cl. G06K 13/08

(52) U.S. Cl. CPC G06K 13/0825; G06K 13/0831

(57) ABSTRACT

The invention relates to an operating apparatus having an operating mechanism for purposefully releasing a card receptacle drawer of a push-push card reader from the latched slide-in position by means of simultaneous two-point operation on two spaced-apart operating sections of the operating mechanism.

The present invention relates to an operating apparatus for a push-push card reader in accordance with claim 1 and also to a push-push card reader having an operating apparatus in accordance with claim 8.

The present invention relates in particular to a rocking operating apparatus for a card reader in accordance with the push-push principle, wherein a first push against a card receiving drawer moves a slide into a resting position that corresponds to the reading position of the card, and a second push causes the card receiving drawer moves back out of its removal position.

The card types to which the present card reader relates are smart cards, micro SD cards and other cards that are generally provided in card readers.

The present invention is therefore suitable for all types of actuable drawers for receiving cards.

Generally, push-push readers comprise a control curve, in particular a heart-shaped control curve, which renders it possible to hold the cards in the reading position after a first push and to latch the corresponding card receiving drawer in order to release said card after a further push and finally to guide said card into a non-reading position in which the card can be removed from the reader.

In general, push-push card readers that are specifically for small card types such as by way of example micro SD cards or transflash cards whose card size is smaller than that of SIMcards or small memory cards are constantly being subjected to miniaturization.

A push-push card reader is thus by way of example disclosed in EP 2 131 305 A2 and said push-push card reader comprises a control curve duct and a control element that is connected to a resilient element and forms a so-called push-push mechanism.

The push-push mechanism that is disclosed in said application renders it possible to embody the control curve duct using only two height differences in relation to the contact carrier base and consequently to achieve a clearly flatter construction height. In addition, it is possible to install a card reader of this type in an overhead position, whereby the card is prevented from falling out.

However, as a result of this increasing miniaturization the problem arises of actuating the push-push card readers of this type or rather actuating the receiving drawers in and out of such push-push card readers.

On the one hand, the problem arises that by means of providing a first push the card receiving drawer can be unintentionally removed from the card reader and, on the other hand, it is not readily possible to prevent the loss of the card receiving drawer.

For this purpose, embodiments are known from the prior art, wherein an operating apparatus is located on the push-push card reader and said operating apparatus can only be actuated by means of a tool.

By way of example, a push-push card contacting apparatus is thus disclosed in the prior art, wherein an opening is provided at the front end face and indeed at the insertion-side front end face of the card receiving drawer and it is possible through said opening to release, that is to say actuate, the operating apparatus using a pointed object.

By way of example, it is possible using a bent office staple to activate the operating apparatus through the opening and in this manner to unlock the card receiving drawer from its latched reading position.

The disadvantage in the case of embodiments of this type is that it is necessary for the user in each case to have a particular tool available or an object to hand in order where necessary to open the push-push card reader in order to insert a card or to remove the card.

The disadvantage therefore in the miniaturized push-push card readers that is disclosed in the prior art is the fact that it is not possible to remove the card receiving drawer in a simple manner.

On the other hand, the disadvantage in the case of card receiving drawers that can be actuated without a tool lies in the fact that the drawer are unintentionally released by means of pressing on the front end face of the card receiving drawer. This can also occur whilst using a device in which a push-push card reading apparatus is installed if the device is carried in a pocket such as for example in the trouser pocket or if said device is unintentionally brought into contact with another object.

In all these cases, the card receiving drawer is unintentionally released and can lead to a loss of the card receiving drawer.

It is therefore the object of the present invention to provide an operating apparatus so as to purposefully release a card receiving drawer of a push-push card reader, wherein on the one hand an actuation is possible without a tool, in other words by hand, and on the other hand, an unintentional, in other words unforeseen, release of the card receiving drawer is purposefully prevented.

This object is achieved with an operating apparatus having the features of claim 1. In addition, a push-push card reader having an operating apparatus in accordance with the invention is proposed in accordance with claim 8.

The basic principle of the present invention is to provide an operating apparatus having a rocking mechanism that comprises two actuating sections and a card receiving drawer is only then released if the two actuating sections are simultaneously actuated by means of a push. In this manner, it can be ensured that if pressure is applied anywhere on the operating apparatus a release is prevented, whereas the probability of forces being applied in an equally spaced apart manner, in other words in a symmetrical manner, on the rocking mechanism is very low. It is therefore necessary for the user to intentionally actuate the rocking mechanism in such a manner that pressure is applied to a respective left-hand actuating section and right-hand actuating section of a resilient strip of the rocking mechanism simultaneously by means of pressing a finger against the operating apparatus so that said operating apparatus is not deflected in a rocking manner, rather is moved as a consequence of the equilibrium of forces in a translational manner and consequently the card receiving drawer is actuated with a first push. As a result of this push, the card receiving drawer can be released from the push-push card reader or rather out of its latched, inserted position.

In a most general description, it is also possible to describe the operating apparatus as an operating apparatus that functions in accordance with a two point actuating principle. In the case of pressing on a single actuating section of the rocking operating apparatus, the rocking mechanism only tilts sideward and, as a consequence of the rotating movement, the force is not transferred into a translational movement. As a consequence, the unintentional actuation of the card receiving drawer is prevented.

In accordance with the invention, an operating apparatus is therefore provided so as to purposefully release a card receiving drawer of a push-push card reader from the latched, inserted position by means of a simultaneous two point actuation at two actuating sections that are spaced apart with respect to one another, wherein the actuating mechanism comprises the following:
a) a rocking mechanism that comprises a resilient strip and two actuating sections that the resilient strip forms and also
b) a coupling means for coupling the rocking mechanism in an articulated manner either in a rocking manner in the case of the asymmetrical two point actuation or translational manner in the case of a symmetrical two point actuation in such a manner that an intentional release of the card receiving drawer from the latched position is rendered possible, whereas in the case of a single point actuation of the rocking mechanism an intentional release of the card receiving drawer from the latched position is prevented.

In other words, a rocking mechanism having a resilient strip is provided and said rocking mechanism functions like a “child's rocker”. The resilient strip comprises two actuating sections. Since the rocking mechanism is coupled to the card receiving drawer in an articulated manner, it is possible for the user to actuate the rocking mechanism with one finger, whereby the user only performs a rocking movement for each application of the push or the force. If, by way of example, the rocking mechanism is pressed in on one side of the resilient strip on its first actuating section, said rocking mechanism tilts like a rocker, without the card receiving drawer of the push-push card reader being actuated. The card receiving drawer is therefore prevented from releasing. If the user presses on the opposite lying end of the rocking mechanism on the resilient strip and indeed on its second actuating section, the rocking mechanism is thus in turn released in a rocking manner (this time in the other rocking direction) and an actuation of the card receiving drawer is likewise prevented.

In addition, in one advantageous embodiment, the push-push card reader comprises a stop against which the central middle section of the resilient strip is supported. The central middle section can be compared to the supporting point of a rocker around which the individual arms of a rocker can move in a rotating manner. This requires that in the case of pressing on the central middle section, a deflection of the rocking mechanism is likewise eliminated.

In contrast, if both the one actuating section of the resilient strip as well as the second actuating section of the resilient strip are pressed simultaneously in accordance with a two point actuating principle and indeed so that an equilibrium of forces prevails, the entire card receiving drawer is thus moved in a translational manner and the conventional push-push mechanism that is disclosed in the prior art is released so that the card receiving drawer can be removed from its reading position.

In one advantageous embodiment, the operating apparatus is embodied in such a manner that the coupling means is embodied in the central middle section of the rocking mechanism so as to connect to a coupling in a movable manner, said coupling being embodied on the insertion-side front face of the card receiving drawer.

As a consequence, it is ensured that, as a result of a simple mechanical connection of the rocking mechanism to the card receiving drawer, said rocking mechanism is coupled in its central middle section to the drawer and the rocking mechanism is consequently arranged symmetrically about a type of center axis.

Furthermore, it is advantageous to embody the operating apparatus in such a manner that the resilient strip forms in each case on the side of the central middle section a respective actuating section and the rocking mechanism is likewise deflected in a rocking manner by means of applying an asymmetrical actuating force to the respective actuating sections, whereby the card receiving drawer is also not intentionally released from the latched position in the case of an asymmetrical two point actuation of the rocking mechanism.

This can be compared approximately to the situation in that a greater load acts upon one side of a rocker than on the other side, whereby a state of equilibrium is not created around the supporting point, rather the rocker is deflected in one direction.

In a further advantageous embodiment, the operating apparatus is embodied in such a manner that the resilient strip is actuated in a linear manner in the direction of insertion S and indeed in the direction of insertion S of the push-push card reader, in other words, the card receiving drawer is actuated in the direction of insertion of the push-push card reader, by means of applying a symmetrical actuating force on the respective actuating sections of the rocking mechanism, whereby the card receiving drawer is intentionally released from the latched position.

Therefore, in accordance with the invention a type of adapter is provided that is arranged at the site of the card receiving drawer on which generally in the case of conventional push-push card readers, the card receiving drawer is actuated by means of a push. Since a rocking mechanism is provided, the actuation of the receiving drawer consequently only occurs after the release in accordance with the invention that is disclosed herein.

In addition, in a further advantageous embodiment, the operating apparatus is embodied in such a manner that the rocking mechanism is actuated in a linear or rather translational manner in the direction of insertion S by means of simultaneously applying an actuating force F1 to the actuating section in the spacing d1 with respect to the central middle section and an actuating force F2 from the spaced other actuating section the spacing d2 from the central middle section, whereby the card receiving drawer is intentionally released from the latched position.

It is further advantageous to embody the rocking mechanism from a resilient clip that is embodied from a resilient strip having two actuating sections that are embodied as resilient arms.

In addition, it is advantageous if the resilient clip is embodied in such a manner that said resilient clip comprises two end-side resilient arms that are connected to the actuating sections by way of connecting sections and in each case a supporting section is arranged on the ends of said resilient arms, and the rocking mechanism is supported in a resilient manner on the card receiving drawer by means of said supporting section or is connected to said card receiving drawer. In this manner, it is possible to provide a rocking mechanism in a cost effective manner that allows a release in a resilient and rocking manner.

A further aspect of the present invention is to provide a push-push card reader having a carrier and a card receiving apparatus that can move back and forth on the carrier so as to receive a card, and also a push-push mechanism so as to lock the card receiving apparatus on the carrier in the case of a first push on the card receiving apparatus into the reading position and so as to release the card receiving apparatus from the carrier in the case of a second push, wherein the card receiving apparatus comprises an operating apparatus as described above.

It is particularly advantageous if the push-push card reader in accordance with the invention forms a stop on its carrier against which the resilient strip is supported by means of its central middle section.

In this manner, it can be ensured that although in the case of a push or in the case of an actuation of the rocking mechanism a symmetrical force engages in the region of its central middle section, only a single point actuation occurs and simultaneously it is ensured in the case of an actuation of this type that the card receiving drawer cannot be actuated.

Combinations of and alternatives to the above described embodiment are likewise the subject matter of the present invention. In addition, it is noted that the exemplary embodiments that are mentioned hereinunder are not limiting, rather only illustrate exemplary embodiments of the present invention.

Further details of the invention are evident in the description of exemplary embodiments with reference to the drawings, in the drawings:

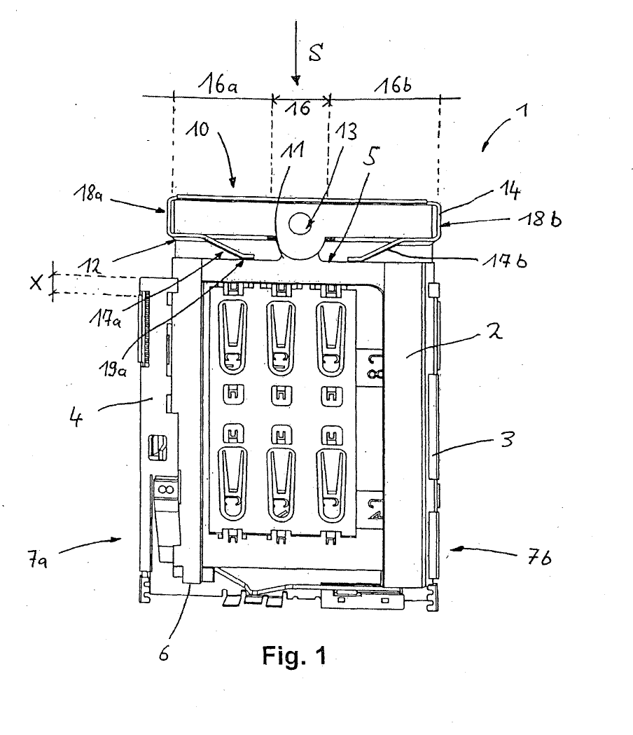

FIG. 1 illustrates a first exemplary embodiment of a push-push card reader in accordance with the invention having a rocking operating apparatus in accordance with the invention,

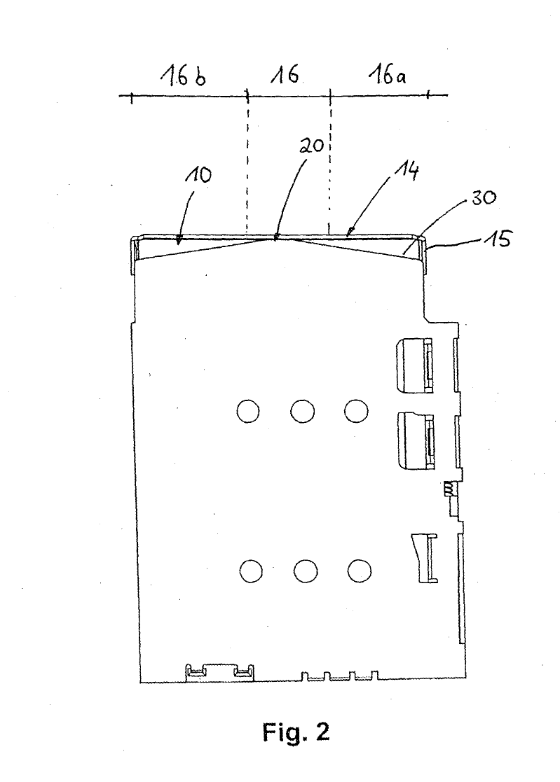

FIG. 2 illustrates a view of the push-push card reader in accordance with the invention in accordance with FIG. 1 from a rear view,

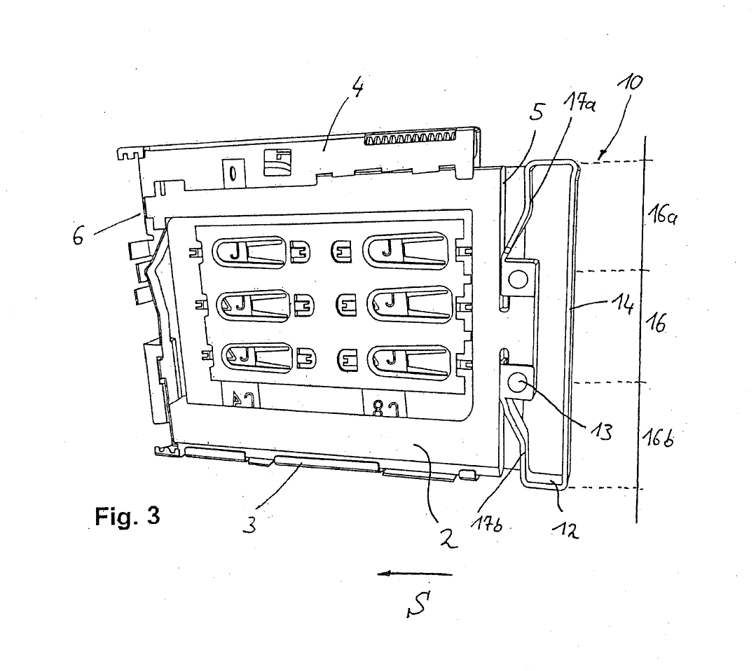

FIG. 3 illustrates a second exemplary embodiment of a push-push card reader in accordance with the invention having an alternative operating apparatus.

FIG. 1 and FIG. 2 illustrate a first exemplary embodiment of a push-push card reader 1 that comprises an operating apparatus 10 in accordance with the invention.

The push-push card reader 1 comprises a carrier 3 in or rather on which is arranged a card receiving apparatus 2 that allows an actuation like a drawer with respect to the carrier 3. The actuation of the card receiving apparatus 2 is possible from a releasing position into a reading position and vice versa.

The push-push card reader 1 comprises a locking and releasing apparatus 4 and indeed a push-push mechanism 4.

A control apparatus having a heart-shaped curve arrangement is suitable as a push-push mechanism 4, as is already known from the prior art. Alternatively, it is possible to use other conventional push-push mechanisms that are suitable for removing the card receiving apparatus by means of a first push from its reading position in order by way of example to insert a card and to carry said card back into its reading position by means of a second push, wherein the push-push mechanism 4 latches the card receiving apparatus 2 in the reading position.

The card receiving apparatus 2 comprises an insertion-side front face 5 and also a rear side 6 that lies opposite the front face 5. In addition, the card receiving apparatus 2 comprises a respective longitudinal side edge 7a, 7b on its longitudinal sides. The card receiving apparatus 2 is used to receive a suitable card for the corresponding push-push card reader 1.

A coupling 11 is located on the front face 5 in order to connect the operating apparatus 10 to the card receiving apparatus 2.

The operating apparatus 10 is formed in the present exemplary embodiment as a rocking mechanism 14 from a resilient strip 12 that extends essentially parallel to the front face 5 of the card receiving apparatus 2. The resilient strip 12 is connected to a respective right-hand side and left-hand side resilient arm 17a, 17b that are each connected to the resilient strip 12 by way of a connecting section 18a, 18b.

In the present exemplary embodiment, the rocking mechanism 14 and therefore the resilient strip 12 and its resilient arms 17a, 17b is formed from a resilient metal sheet and is bent multiple times in order to achieve the shape that is illustrated in FIG. 1.

The rocking mechanism 14 is connected by way of a coupling means 13 to the coupling 11 in a rotatable manner.

In other words, the resilient strip 12 or rather the rocking mechanism 14 forms a rocker whose point of rotation is formed by the coupling 11 and the coupling means 13. The resilient strip 12 comprises a central middle section 16 that is located in the region of the coupling 11 and the coupling means 13 in the direction of insertion S of the card receiving apparatus 2.

The resilient strip comprises adjacent to the central middle section 16 on the left-hand side and the right-hand side respectively an actuating section 16a, 16b. If the user presses by way of example on one of the actuating sections 16a, 16b, the rocking mechanism 14 is deflected in a rocking manner. If a user by way of example presses the actuating section 16a in FIG. 1 of the left-hand section of the resilient strip 12, the supporting end 19a of the resilient strip 17a slides along on the front face 5 of the card receiving apparatus 2, whereas the rocking mechanism 14 is actuated like a rocker and the opposite lying actuating section 16b is moved away from the front face 5 of the card receiving apparatus 2. The same occurs in the reversed movement direction provided that pressure is applied to the actuating section 16b, for example by a finger.

The operating apparatus 10 therefore comprises a two-point actuation to such an extent that a translational movement in the direction of insertion S of the card receiving apparatus 2 is only then possible if the actuating section 16a and the actuating section 16b are pressed simultaneously, so that the rocking mechanism 14 is not deflected in a rocking manner, rather by means of synchronized force actuation by way of applying a force by way of the coupling means 13 and the coupling 11 the card receiving apparatus 2 experiences a translational movement in the direction of insertion S and therefore covers the necessary path X in such a manner that the push-push mechanism 4 releases in order to release the card receiving apparatus 2.

The path X describes therefore the necessary actuating path in order to release the push-push mechanism 4. Provided that consequently an actuation of the card receiving apparatus 2 is performed, whose deflection in the direction of insertion is smaller than that of the actuating path X, the push-push mechanism 4 is not released, which is the case in the case of a single sided actuation of the rocking mechanism 14.

This is consequently always the case if only one actuating section of the actuating sections 16a, 16b is pressed. In these cases, only the rocking mechanism 14 is released and where necessary the card receiving apparatus 2 moves along a minimal in any case markedly smaller path than the necessary actuating path X.

As a consequence, it is ensured that only as a result of a simultaneous actuation, so to speak a two point actuation of the operating apparatus 10, it is possible to release the push-push mechanism 4 so that the card receiving apparatus 2 can be removed.

On the other hand, it is ensured that as a result of any unintentional single point actuation along the resilient strip 12 only a tilting or rather rocking movement of the rocking mechanism 14 occurs and an unintentional release of the card receiving apparatus 2 is consequently prevented.

FIG. 2 illustrates how it can be ensured that in the case of a push on the central middle section 16 likewise an unintentional actuation of the push-push mechanism 4 and therefore a release of the card receiving apparatus 2 occurs as a result of a push on only one actuating point.

As is evident, the carrier 3 comprises a stop 20 on its front edge 30. This stop 20 can be embodied as in the exemplary embodiment in FIG. 2 in such a manner that the carrier 3 forms a front edge 30 that is similar to an arrow whose point forms the stop 20. The stop 20 lies against the resilient strip 12 in the region of the central middle section 16 so that it is not possible to actuate or to push-in the resilient strip 12.

However, if, in the view in accordance with FIG. 2, the two actuating sections 16a, 16b are pressed and therefore a two point actuation occurs simultaneously, the resilient clip 15 is thus bent and the rocking mechanism 14 is not actuated, rather a bending deflection of the resilient strip 12 occurs in each case in the first actuating section 16a and the second actuating section 16b in such a manner that the resilient arms 17a, 17b or rather their supporting ends 19a, 19b press against the front face 5 of the card receiving apparatus 2 so that a deflection along an actuating path X occurs, whereby the push-push mechanism 4 is released.

However, if one of the two actuating sections 16a, 16b is released, the corresponding part of the resilient strip 12 springs back and a tilting rocking movement of the rocking mechanism 14 occurs so that a deflection of the push-push mechanism 4 can no longer occur.

FIG. 3 illustrates an alternative exemplary embodiment of the invention.

Identical reference numerals denote identical components.

In this case, the operating apparatus 10 likewise comprises a resilient strip 12 and two resilient arms 17a, 17b that are connected to the resilient strip 12 by way of connecting sections 18a, 18b. The ends of the resilient arms 17a, 17b are connected to the coupling 11 of the card receiving apparatus 2.

The rocking mechanism 14 that is depicted here does not rock in the identical manner corresponding to the rocking mechanism of the first exemplary embodiment in accordance with FIG. 1 and FIG. 2, but it is likewise subject to a rocking movement, wherein one of the two actuating sections 16a or 16b is pressed. If in this case the central middle section 16 is pressed, only the resilient strip 12 bends without a sufficient translational movement of the card receiving apparatus 2 along an actuating path X. On the contrary, it is necessary to simultaneously press both the actuating section 16a and the actuating section 16b so that the resilient arms 17a, 17b are in any case loaded in such a manner by means of bending the resilient strip 12 that the required actuating path X occurs in the direction of insertion S of the card receiving apparatus 2 and, as a consequence, the push-push mechanism 4 is released.

### LIST OF REFERENCE NUMERALS

1 Push-Push Card Reader
2 Card Receiving Apparatus
3 Carrier
4 Locking and Releasing Apparatus (Push-Push Mechanism)
5 Front Face
6 Rear Side
7a Longitudinal Side Edge
7b Longitudinal Side Edge
10 Operating apparatus
11 Coupling
12 Resilient Strip
13 Coupling Means
14 Rocking Mechanism
15 Resilient Clip
16 Middle Section
16a Actuating Section
16b Actuating Section
17a Resilient Arm
17b Resilient Arm
18a Connecting Section
18b Connecting Section
19a Supporting Section
19b Supporting Section
20 Stop
30 Front Edge
S Direction of Insertion
X Actuating Path
F1 Actuating Force
F2 Actuating Force
d1 Spacing
d2 Spacing

1. An operating apparatus having an actuating mechanism so as to purposefully release a card receiving drawer of a push-push card reader from the latched, inserted position by means of a simultaneous two point actuation at two actuating sections of the actuating mechanism that are spaced apart with respect to one another, wherein the actuating mechanism comprises the following:
a) a rocking mechanism that comprises a resilient strip and two actuating sections and
b) a coupling means for coupling the rocking mechanism in an articulated manner to the card receiving drawer so that it is possible to actuate the rocking mechanism either in a rocking manner in the case of an asymmetrical two-point actuation or in a translational manner in the case of a symmetrical two-point actuation at the actuating sections, in order to intentionally release the card receiving drawer from the latched position, whereas in the case of a single point actuation of the rocking mechanism an intentional release of the card receiving drawer from the latched position is prevented.

2. The operating apparatus as claimed in claim 1, characterized in that the coupling means is embodied in a central middle section of the rocking mechanism so as to connect to a coupling in a movable manner, said coupling being embodied on the insertion-side front face of the card receiving drawer.

3. The operating apparatus as claimed in claim 1, characterized in that the resilient strip forms in each case on the side of the central middle section a respective actuating section and the rocking mechanism is deflected in a rocking manner by means of applying an asymmetrical actuating force F1 to the respective actuating sections, whereby an intentional release of the card receiving drawer from the latched position is not performed or is prevented.

4. The operating apparatus as claimed in claim 1, characterized in that the resilient strip is actuated in a linear manner in the direction of insertion S by means of applying a symmetrical actuating force F1 to the respective actuating sections of the rocking mechanism, whereby the card receiving drawer is intentionally released from the latched position.

5. The operating apparatus as claimed in claim 1, characterized in that the rocking mechanism is actuated in a linear or rather translational manner in the direction of insertion S by means of simultaneously applying an actuating force F1 to the actuating section in the spacing d1 from the central middle section and an actuating force F1 to the actuating section in the spacing d1 from the central middle section, whereby the card receiving drawer is intentionally released from the latched position.

6. The operating apparatus as claimed in claim 1, characterized in that the rocking mechanism comprises a resilient clip that is embodied from a resilient strip having two actuating sections that are embodied as resilient arms.

7. The operating apparatus as claimed in claim 6, characterized in that the resilient clip comprises two end-side resilient arms that are connected to the actuating sections by way of connecting sections and in each case a supporting section is arranged on the ends of said resilient arms, and the rocking mechanism is supported in a resilient manner on the card receiving drawer by means of said supporting section.

8. A push-push card reader having a carrier and a card receiving apparatus that can move back and forth on the carrier so as to receive a card, and also a push-push mechanism so as to lock the card receiving apparatus on the carrier in the case of a first push of the card receiving apparatus into the reading position and so as to release the card receiving apparatus from the carrier in the case of a second push, characterized in that the card receiving apparatus comprises an operating apparatus as claimed in claim 1.

9. The push-push card reader as claimed in claim 8, characterized in that a coupling is attached to the front face of the card receiving apparatus and the operating apparatus is coupled to said coupling with its coupling means in an articulated manner.

10. The push-push card reader as claimed in claim 8, characterized in that the carrier forms a stop against which the resilient strip is supported by means of its central middle section.
